(19) United States
(12) Patent Application Publication
(10) Pub. No.: US 2011/0133441 A1
(43) Pub. Date: Jun. 9, 2011

(54) BOOK WITH INTERACTIVE ELEMENT

(75) Inventor: Shari Kaufman, Westport, CT (US)

(73) Assignee: Innovative U.S.A., Inc., Norwalk, CT (US)

(21) Appl. No.: 12/633,889

(22) Filed: Dec. 9, 2009

(51) Int. Cl. B42D 3/00; B42C 3/00

(52) U.S. Cl. 281/29; 281/38; 412/4

(57) ABSTRACT

A book having at least one bound-in removable interactive element is described. The book is constructed from material having sufficient rigidity and structural integrity to maintain the shape of the cover and each page while still facilitating efficient removal and insertion of individual removable interactive elements. The removable interactive elements are preferably formed by die-cutting a cover or page of the book such that the desired shape and its corresponding outline are formed. No backing material is provided on either side of the cover or page such that each removable interactive element may be inserted or removed from either side. This facilitates greater interactivity and flexibility in its use. The removable interactive element may be used as an object of play, as a puzzle piece, in a game, as part of a story, or in any other activity either within or outside the book.

### BACKGROUND OF THE INVENTION

I. Field of the Invention

The present invention relates generally to a book having a bound-in removable interactive element. More particularly, the present invention relates to a book having at least one cover or page comprising at least one bound-in removable interactive element that is functional both separate from and within the book. The invention also relates to an interactive element that is integral with and can be removed through either side of a cover or page.

II. Background of the Related Art

A variety of books are currently on the market which are provided with, for example, puzzles as well as manipulative and interactive pieces for use with the book. These types of books have an especially high educational value for children. One example is a book provided with manipulative pieces which may be placed on a page of the book to complete a picture on the page. In another example, a number of manipulative pieces need to be placed adjacent to each other in order to complete a picture. In some instances, the pieces are assembled in a manner analogous to a jigsaw puzzle.

An example of a puzzle book is provided by U.S. Pat. No. 5,857,706 to McQueeny which incorporates a plurality of interlocking puzzle pieces disposed in a cavity on the exterior side of the front cover. Similarly, U.S. Pat. No. 5,213,507 to Ozrovitz discloses a child's story and picture book having at least one page which includes text on one or more sides and a puzzle on the other side. The puzzle has a plurality of interlocking puzzle pieces that fit into a cavity centered on a page. Another example is provided by U.S. Pat. No. 6,702,586 to Miller which discloses a book with puzzle parts included in the pages of the book for use in combination with a board.

In the examples provided above, the puzzle pieces or game pieces within the book are constrained to specific recessed locations provided within a particular cover or page. Furthermore, the recessed portions are supported by a backing material which closes off the rear of the recessed portion. It is not possible to use the pieces in multiple instances such as within a plurality of recessed portions on the same page or throughout the book. Furthermore, these puzzles provide minimal or no interactivity with the book itself. Accordingly, the use of components provided within books disclosed in the prior art is unduly limiting. It is therefore desirable to provide books with interactive pieces which provide the user with a higher degree of interactivity.

### SUMMARY OF THE INVENTION

The present invention is directed to a book comprising a front cover, a back cover, at least one page between the front and back covers, a binding means, and at least one bound-in removable interactive element having a front and back side, wherein the front and back sides of the removable interactive element are integral with front and back sides of the front cover, back cover, or page of said book. The bound-in removable interactive element is provided by die-cutting the interactive element into the covers or pages of the book. Further, the bound-in interactive element is constructed of a material that is substantially the same as the front cover, back cover and pages of the book. In alternative embodiments the front cover, back cover, and pages of the book may comprise any combination of different materials. The bound-in removable interactive elements may be the same or a different material as that used for the page or cover in which it is contained. The die-cut bound-in removable interactive element has substantially the same width as the front and back covers and pages of the book, and optionally, comprises printing on its front and back surfaces.

According to one embodiment of the invention, the front cover, back cover and the pages of the book are prepared from supporting material of sufficient rigidity and structural integrity to facilitate die-cutting of bound-in removable interactive elements having various interactive shapes while retaining the outline of the thus-formed shape in the cut material. Further, the front and back covers and pages of the book along with the removable interactive element are comprised of the same supporting material so that the removable interactive element can be removed and inserted from the covers or pages of the book without loss of the book's overall structural integrity. In still another embodiment the plurality of components, including the front and back covers, pages, and individual interactive elements may each comprise a different material.

The shapes of the removable interactive elements may be configured such that they can be removed from the book and used in a story, game, puzzle, or other activity within or apart from the book. When complete, the removable interactive elements can be re-inserted into its outline in the supporting material of the covers or pages of the book. Optionally, the supporting material also has a surface, or laminate, capable of being printed upon such that words, pictures, or drawings and the like, may be formed thereon. Supporting material which has been printed, cut, and sized may be incorporated as a cover and/or one or more pages in a book. By combining a plurality of these pages, an activity, story, or game which includes these removable interactive elements may be created for use within or apart from the book.

Accordingly, these objects and others are achieved by the book of the present invention which comprises a front cover, a back cover, and at least one page between the front and back covers. The front cover, back cover, and at least one page are bound together by a binding means. At least one of the front cover, back cover, and a page of the book comprises at least one outline of a shape formed therein and a corresponding die-cut bound-in removable interactive element having an analogous shape. It is a further object of the present invention to provide a book which employs die-cut bound-in removable interactive elements in a manner such that they cooperate to form a picture, present a story, play a game, puzzle, or other activity either within or apart from the book.

Also contemplated within the scope of the present invention is the provision of a means for holding the die-cut bound-in removable interactive elements. According to one embodiment of the invention, this is accomplished by a “press-in fit” effect in which the bound-in removable interactive element maintains its integral position within the covers or pages of the book by a precise die-cut fit within the supportive material. Accordingly, once the removable interactive element is placed within the appropriately sized die-cut of the covers or pages of the book, the front and back surfaces of the removable interactive element are virtually flush or level with the surfaces of the covers and pages. The press-in fit being so exact that once the removable interactive element is placed into the die-cut space of the covers or pages of the book, the shape of the bound-in removable interactive element is substantially indistinguishable from the corresponding cover or page surface.

According to yet another embodiment of the invention, the removable interactive elements may also be provided with a magnetized surface, light source, sound capabilities, or interactivity with stickers or any other element known to those skilled in the art.

### BRIEF DESCRIPTION OF THE DRAWINGS

FIG. 1 shows an offset side view of an embodiment a book of the present invention in the closed position;

FIG. 2 depicts an offset front view of another embodiment of a book of the present invention in the open position with removable interactive elements provided within the pages of the book;

FIG. 3 shows an offset front view of the embodiment in FIG. 2 in which a plurality of interactive elements have been removed from the page and used either outside the book or on a different page;

FIG. 4A shows an offset view of another embodiment of the book which shows a bound-in removable interactive element contained within a printed character on a page;

FIG. 4B shows an offset view of the embodiment in FIG. 4A in which the opposite side of the page is shown with the interactive element removed; and

FIG. 4C is a reproduction of the view in FIG. 4B in which the interactive element has been flipped and re-inserted into the page.

### DETAILED DESCRIPTION OF THE INVENTION

The above and other objectives of the invention will become more apparent from the following description and illustrative embodiments which are described in detail with reference to the accompanying drawings. Similar elements in each Figure are designated by like reference numbers and, hence, subsequent detailed descriptions thereof may be omitted for brevity.

The present invention relates generally to a book comprising a die-cut bound-in removable interactive element. The pages and covers of the book are constructed from a material of sufficient rigidity and structural integrity to facilitate insertion and removal of at least one removable interactive element provided in at least one page or cover. The removable interactive element is contained entirely within and is supported by either a page of the book, a front cover, or a back cover. The support required to secure the removable interactive element to the page or cover is provided by the “bound-in fit” between the removable interactive element and its outline within the page or cover of the book. The secured bound-in fit is made possible by the precise die-cutting and materials, e.g., expanded polystyrene or any material with similar properties, used to make the removable interactive element as well as the covers and/or pages of the book. The precise die-cutting and physical properties of the material, e.g., compressibility and uneven texture of the polystyrene edges, provides for a secure bound-in fit, which facilitates insertion and removal of the interactive element. The choice of materials also provides for greater flexibility in the use of the removable interactive element in, for example, a game, story, puzzle, or other activity that is provided within or apart from the book.

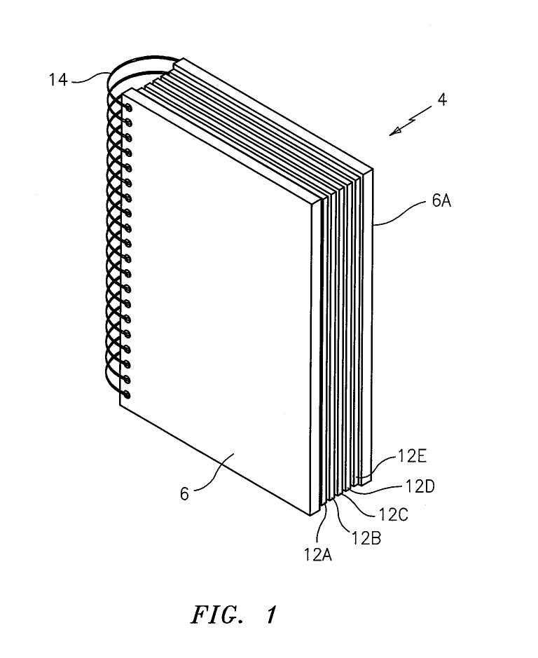

Referring to FIG. 1, there is shown an offset front view of an embodiment of the book (4) of the present invention. The exemplary book (4) shown in FIG. 1 has a front cover (6), a back cover (6A), and five pages (12A), (12B), (12C), (12D), and (12E). The front cover (6), back cover (6A), and pages (12A-E) can be constructed of material which provides sufficient structural integrity, rigidity, and printability on its surfaces. These materials may include but are not limited to a lightweight material such as paper, cardboard, textiles, foam, rubber, wood, plastics, EVA foam, and the like. According to one specific embodiment of the invention, the book is constructed from an expanded polystyrene (EPS) material that can be die-cut into a variety of shapes to accommodate bound-in removable interactive element(s) of various shapes. The materiel used to prepare the covers or pages, e.g., EPS, can be laminated with other materials, as is know in the art. Laminating can be performed on, for example, paper, plastic, wood, veneer, and fabric. In other embodiments the cover(s) (6) and (6A) along with page(s) (12A-E) may be screen printed, offset printed, colored, or otherwise treated with coatings and/or laminates as desired. According to another specific embodiment of the invention, the printing on the cover(s) (6) and (6A) and page(s) (12A-E) have a related theme such as a story or the like. The cover and page thicknesses are usually such that the book is easy to handle even for small children. The page thickness preferably ranges from about 1/32 to about ¼ of an inch. In an especially preferred embodiment the page is about 1/16 of an inch thick. Any suitable thickness can be used as long as it is sufficient to provide the qualities of rigidity, workability, press fit, and compression required for manufacturing and normal use.

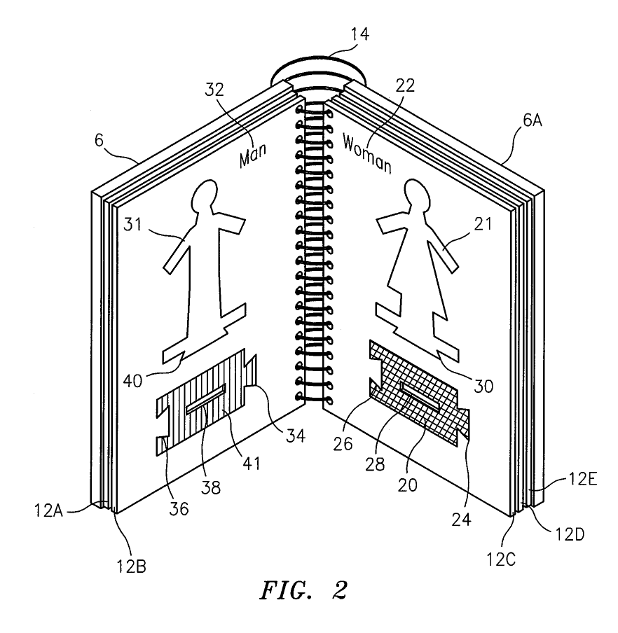

The front and back surfaces of the removable interactive element(s) are substantially flat with the surfaces of the page or cover in which they are contained. That is, when fully seated, or “bound-in,” the surface of the cover or page appears essentially continuous to an ordinary observer with no breaks, steps, or corrugations being present on the surface. The lettering or graphics formed on the page may or may not reveal the location and shape of the removable interactive element depending on the particular story, game, or activity being displayed. Furthermore, the lettering or graphics may be designed such that when the removable interactive element is taken out from its location within a cover or page of the book, other pictures and/or puzzles may be revealed. The pictures/puzzles on one cover or page may be associated with those on a subsequent page or cover. This interactivity may also extend to removable interactive elements which are taken from different components and used together either outside of the book or within the book. As will be described using the examples below in combination with FIGS. 2-4, a removable interactive element may be taken out of one page and inserted into another page or combined with another removable interactive element. Multiple removable interactive elements may be combined either within another location in the book or separate from the book. In this manner the graphics throughout the book may be customized and an additional degree of interactivity is provided to the user.

The five pages (12A-E) of the exemplary book (4) are bound along one side by a binding means (14) to form the book (4). In a preferred embodiment the front cover (6), back cover (6A), and pages (12A) through (12E) are bound together by a spiral wire (14) to form a spiral-bound book. In an alternative embodiment the book may be bound together by a suitable adhesive which is known to those of ordinary skill in the art. An exemplary adhesive system would comprise the combination of heating and melting a type of glue to bind all of the elements together. With specific reference to the spiral wire (14) illustrated in FIG. 1, the wire extends through a series of holes positioned in a row along the back edges of the top (6) and bottom (6A) covers as well as pages (12A-E). In alternative embodiments other suitable binding means (14) may be employed. Examples include ring binding, male/female mating-type bindings, stitching, and slide-on type clip bindings. The binding means can be the same material as the covers and pages of the book, or it may be constructed from a different material.

The book (4) illustrated in FIG. 1 is shown in a closed position with the covers (6) and (6A) having a thickness and external dimensions which are slightly greater than that of the pages (12A-E). It is contemplated that the nature of the present invention provides for a book which exhibits the proper size, page thickness, tactility, rigidity, and durability to be repeatedly opened and played with. This includes repeated removal and insertion of one or more die-cut bound-in removable interactive elements which will be described more fully herein below, with reference to FIGS. 2-4. According to yet another specific embodiment, the book (4) is formed from the desired material and the removable interactive element(s) are formed by die-cutting into individual covers (6) and (6A) or pages (12A-E) of the book. The components are assembled as described above in order to form the book (4). It is to be understood, however, that a plurality of alternative cutting and forming means which are well-known in the art may be employed. Furthermore, the covers (6, 6A) as well as any page(s) (12A-E) may be formed or cut into any desired size(s) or shape(s). This includes animals, cartoon characters, people, numbers, symbols, figurines, structures, places, dolls, works of art, and so forth. Where only the covers are shaped, the interior page(s) may be shortened so that they do not extend outside of the cover if desired.

In FIG. 2, an offset front view of an embodiment of the book (4) in the open position is provided. The front (6) and back (6A) covers as well as a plurality of interior pages (12A) through (12E) are shown. In the embodiment shown in FIG. 2, the book is opened to pages (12B) and (12C). Although it is contemplated that the thicknesses of the front cover (6), interior pages (12A-E), and the back cover (6A) may be essentially equal, in alternative embodiments each component may be of different thicknesses in order to provide the page with, for example, a popout or some other function. FIG. 2 shows an embodiment in which the book (4) includes a plurality of removable interactive elements (20, 21, 31, and 41) on pages (12B) and (12C). Although in this embodiment the removable die-cut bound-in removable interactive elements are described and shown as being contained within the two interior pages (12B) and (12C), it is to be understood that it can also be formed within any of the plurality of other pages (12A and 12D-E) as well as the front (6) and back covers (6A) of the book. The removable interactive elements (20, 21, 31, and 41) are die cut into the desired shape, thereby leaving an analogously shaped outline in the page which facilitates insertion and removal of the removable interactive elements. The cutting process is such that a tight fit (i.e., “bound-in fit”) is maintained between the removable interactive element and its respective outline. This ensures that the removable interactive element can be firmly secured in place when inserted into the outline.

The pages (12A-E) are made of a material having sufficient rigidity and thickness to facilitate ease of removal of the removable interactive elements while still providing for secure attachment within its outline. The bound-in fit is preferably sufficient to maintain the removable interactive elements in position despite rigorous and repeated transport and/or opening and closing of the book (4). The bound-in fit between the removable interactive elements and their corresponding outline may be adjusted by, for example, adjusting the thickness of the base material or increasing the tightness of the bound-in fit between them. It is to be noted that no backing material or impediment is provided either in front of or behind the outlines formed on each page. Thus, the removable interactive elements may be inserted and removed from either side of the cover or page in which it is contained. When the removable interactive element is removed from its outline it may reveal, for example, a word or graphic on an adjacent page. As previously indicated, the removable interactive elements may also be designed such that a plurality of removable interactive elements may interact outside of the book (4) to form, for example, a puzzle.

The removable interactive elements may be fabricated from the same material as the cover or page in which it is contained or a different material and to either the same or a different thickness. However, removable interactive elements comprised of a different material or thicknesses are fashioned to maintain their die-cut bound-in fit within the cover(s) or page(s). As an example, the removable interactive element may be thinner than the cover or page such that it is recessed within the outline or it may be thicker than the cover or page such that it protrudes from one or both sides. If the removable interactive element and cover/page are manufactured from the same material, each may be cut from a separate sheet and then joined at a later stage to maintain a tight press fit between the removable interactive element and its corresponding outline.

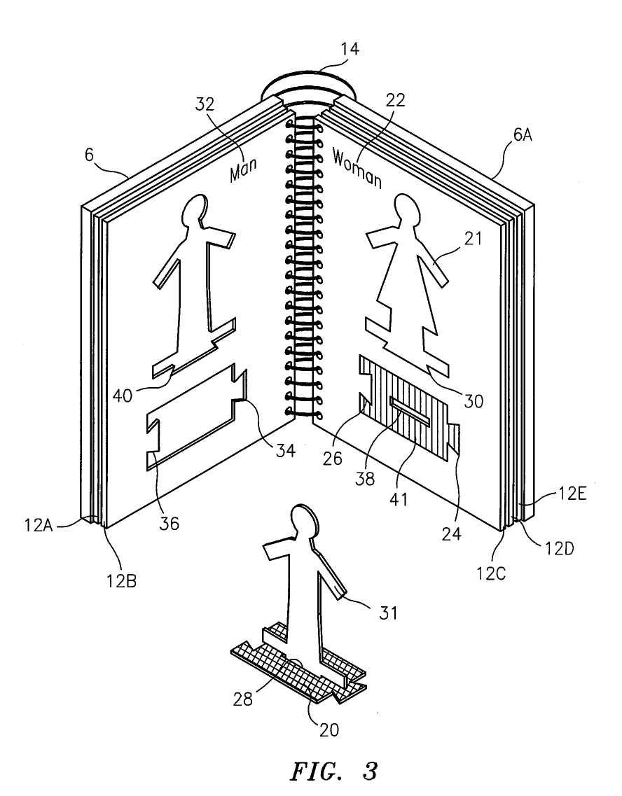

The interactivity between the plurality of removable interactive elements and printed characters is further illustrated in FIGS. 2-3. On page (12C) in FIG. 2, one removable interactive element is provided in the shape of a woman (21) and the second removable interactive element is a stand (20) for removable interactive element (21). On the opposing page (12B), a removable interactive element in the shape of a man (31) is provided along with another stand (41). It can be appreciated that the inserts (30) and (40) provided at the base of removable interactive elements (21) and (31), respectively, will fit into slots (28) and (38) of each stand (20) and (41), respectively. When a stand (20) is removed from the page and placed on a flat surface, the insert (30) or (40) of a removable interactive element (21) or (31) can be placed into slot (28) or (38) such that the removable interactive element(s) can be erected vertically. In FIG. 3, stand (20) has been removed from page (12C) and interactive element (31) has been removed from page (12B). The insert (40) of interactive element (31) has been fitted to the slot (28) of stand (20) such that the assembly is free-standing. FIG. 3 also shows that stand (41) has been transferred from its outline within page (12B) to the corresponding outline within page (12C). This is intended to provide an example of the type of interactivity attainable between interactive elements both within and outside the book.

Each stand (20) and (41) illustrated in FIGS. 2-3 is also provided with a dovetail (24), (34) and mortise (26), (36) such that it can form a puzzle piece for cooperation with other removable interactive elements contained within the book (not shown). Pages (12B) and (12C) are also provided with silkscreen printing (22) and (32) which may, for example, identify the removable interactive element or tell a story which corresponds with the removable interactive elements (21) and (31). In this manner, a user such as a child can read a story and play with the removable interactive elements which are components which make up the story itself.

As FIGS. 2-3 show, when a plurality of pages have similarly shaped removable interactive elements they may be used interchangeably. That is, each removable interactive element is capable of being inserted into one or more pages to provide greater interaction and flexibility within the story, activity, or game being played. In addition, removable interactive elements from different pages may be capable of interlocking with each other as via a dovetail (24), (34) and mortise (26), (36) as shown in FIGS. 2-3 or in a manner akin to pieces of a jigsaw puzzle. Although only two removable interactive elements are shown on each page in FIGS. 2-3, it is to be understood that one or a plurality of removable interactive elements may be printed and die cut from the page. The resulting shapes can be used to construct, for example, a play scene, a dinosaur sculpture, a race car, a game, and so forth. Since the removable interactive elements are contained within a book, a story can be created around the sculpture, game, or play scene. The story itself may be printed onto the pages of the book or on one or more removable interactive elements to create a type of three-dimensional book. Furthermore, the shape and construction of the removable interactive elements do not have to precisely mirror their outline. For example, with respect to FIGS. 2-3, the man (31) or woman (21) may be missing one or more arms and still be capable of fitting securely within its corresponding outline in the page.

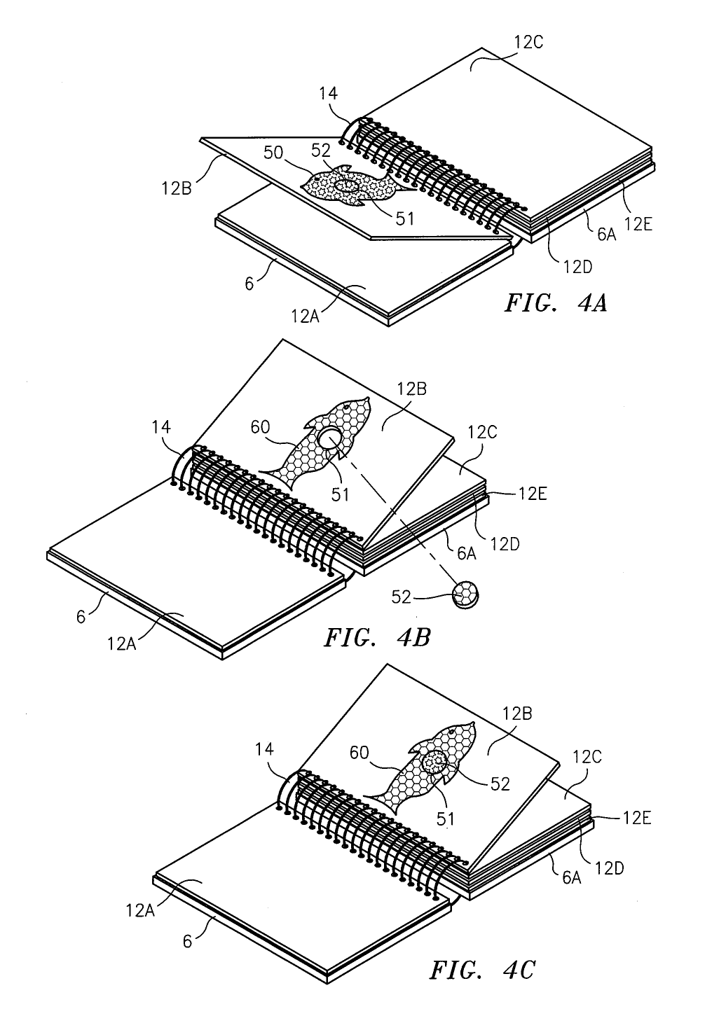

FIGS. 4A-C show another embodiment of the invention which demonstrates the interactivity between opposing sides of the same page. In FIG. 4A, a fish (50) having a specific pattern is printed on one side of page (12B) whereas FIG. 4B shows that the opposite side of the same page has another fish (60) colored with a different pattern. FIGS. 4A-C also show that a removable interactive element (52) and its corresponding outline (51) are located within a center region of each fish (50) and (60). FIG. 4A shows that when situated in its original position integral with a surface of the page (12B), the interactive element (52) is substantially indistinguishable from the rest of the page (12B). The only feature visible is the outline (51) of the interactive element (52).

FIG. 4B shows that the opposing side of the removable element (52) is provided with a pattern which matches fish (60). The interactive element (52) may be removed (as shown, for example, in FIG. 4B) from either side of page (12B) and then reinserted into the same or a different page. In FIG. 4C, the interactive element (52) has been rotated 180° and reinserted into the page such that the pattern from fish (50) is now shown on the side of page (12B) containing fish (60) and vice versa. As FIGS. 4A-C show, a plurality of removable interactive elements (52), each of which has a different pattern formed thereon may be used interchangeably with similar outlines (51) on different pages or covers. This permits a user such as a young child to create unique characters having different combinations of patterns formed thereon.

The interactive elements shown and described in FIGS. 2-4 are preferably formed by die-cutting the material constituting the page. It is to be understood, however, that the cutting process is not limited to die-cutting and any suitable cutting process may be used. By die-cutting the desired shapes the thus-formed removable interactive elements appear essentially continuous with the page or cover itself. That is, the cutting lines are virtually indistinguishable from the rest of the page or cover, forming a substantially smooth and continuous surface as would be found from an uncut page or cover.

The use of a plurality removable interactive elements which can be inserted/removed from either side of the front cover, back cover, or any of the pages of the book lends itself to a large number of possible uses or combination of uses which are recognized as being within the spirit and scope of the present invention. A number of possible variants will now be described in detail below. It is to be understood, however, that the invention is not limited to those variants disclosed below.

In one embodiment of the invention, the book (4) is equipped with a storage compartment or pouch which is capable of storing the removable interactive elements when not in use. This may be in the form of, for example, a substantially cylindrical tube which is attached to the back cover as described in U.S. Pat. No. 6,247,729 to Shari Kaufman which is incorporated by reference as if fully set forth in this specification. The tube is equipped with a type of cap which may be opened and closed to gain access to the pieces stored therein. It is noted that the use of any storage compartment is not critical to the present invention and any storage means may be employed without departing from the spirit of the claimed invention. The use of such a storage compartment provides removable interactive elements which may, for example, be inserted into the front/back covers or pages of the book while reading a story or playing a game. Use of a storage compartment minimizes the probability that removable interactive elements become lost when not in use. The storage compartment may also be used to provide extra pieces in the event a removable interactive element becomes damaged or lost.

In another embodiment the removable interactive elements may be provided with a magnetized material such that the removable interactive element will adhere to, for example, a suitable metal surface. The magnetized material may be fastened to one side or to a specific location on the removable interactive element in any manner which is well-known to those skilled in the art. Typically the magnet is in the same shape as the removable interactive element and is glued to the bottom side of the removable interactive element using an adhesive. The magnet itself may be of any thickness and strength sufficient to cause the manipulative to attach to a sheet of metal or to another magnet of opposite polarity. An example is provided by U.S. Pat. No. 5,820,383 to Michael Levins which is incorporated by reference as if fully set forth in this specification. The magnetized removable interactive element(s) may be contained within the cover or pages of the book in a manner analogous to that shown in FIGS. 2-4. When removed from its outline within the book the magnetized removable interactive element may, for example, be attached to a surface within the book or to one or more other removable interactive elements. Assembly may be in a manner analogous to a puzzle or to construct a three-dimensional shape.

In still another embodiment, the book may comprise removable interactive elements which are employed in a variety of games. Examples include checkers, chess, backgammon, and the like. The game board itself may be contained within a page of the book and the game pieces contained within cutouts formed within the page. The game pieces themselves may be constructed by die-cutting the page or cover or the game pieces may be constructed and provided separate from the book. The removable interactive element would be round discs for checkers and backgammon and chess men for chess. The game itself may be played within the book itself, on a pull-out, or on a separate game board. When played within, for example, a page of the book the pieces may be moved by removal from one location and insertion in a different location. Furthermore, when used within a page or cover, the tight fit between the removable interactive element and its outline facilitates maintaining the removable interactive element in a specified position.

Additional embodiments relate to the use of the removable interactive element(s) in conjunction with, for example, stickers, lights, and sounds. For example, the removable interactive element may have a surface suitable for the adhesion and removal of stickers. In another instance the removable interactive elements may be of sufficient size and thickness to contain a source of light such as a light emitting diode and accompanying power source. The power source may be a small battery or even a solar cell attached to one side of the removable interactive element. The source of light and its power source are contained entirely within the removable interactive element and the light source may be activated by, for example, a pressure sensitive switch. In this manner the light source can be activated either within the book or separate from it depending on whether the removable interactive element is inserted into an outline or not. In still another example the removable interactive element may comprise a miniature speaker which is encapsulated within the removable interactive element itself in a manner analogous to that described above for the light source in order to produce a desired sound effect. The magnets, stickers, lights, and sounds may be used in conjunction with a game, activity, or story which is provided within the pages of the book or on other removable interactive elements.

It will be appreciated by persons skilled in the art that the present invention is not limited to what has been particularly shown and described hereinabove. Rather, the scope of the present invention is defined by the claims which follow. It should further be understood that the above description is only representative of illustrative examples of embodiments. For the reader's convenience, the above description has focused on a representative sample of possible embodiments, a sample that teaches the principles of the present invention. Other embodiments may result from a different combination of portions of different embodiments.

The description has not attempted to exhaustively enumerate all possible variations. The alternate embodiments may not have been presented for a specific portion of the invention, and may result from a different combination of described portions, or that other undescribed alternate embodiments may be available for a portion, is not to be considered a disclaimer of those alternate embodiments. It will be appreciated that many of those undescribed embodiments are within the literal scope of the following claims, and others are equivalent. Furthermore, all references, publications, U.S. patents, and U.S. patent Publications cited throughout this specification are hereby incorporated by reference as if fully set forth in this specification.

What is claimed is:

1. A book comprising a front cover, a back cover, at least one page between the front and back covers, a binding means, and at least one bound-in removable interactive element having a front and back side, wherein the front and back sides of the removable interactive element are integral with front and back sides of the front cover, back cover, or page of said book.

2. The book as described in claim 1 wherein the bound-in removable interactive element is die-cut within at least one of said front cover, back cover, and at least one page.

3. The book as described in claim 1 wherein the bound-in removable interactive element is constructed of material that is substantially the same or different as the front cover, back cover and at least one page.

4. The book as described in claim 1 wherein the bound-in removable interactive element is removable from the front side or back side of the front cover, back cover and at least one page.

5. The book as described in claim 3 wherein said material is selected from the group consisting of EPS and EVA foam.

6. The book as described in claim 1 wherein the bound-in removable interactive element has various shapes.

7. The book as describe in claim 1 wherein the shapes of the bound-in removable interactive elements are configured to provide a story, game, puzzle, or other activity within or apart from the book.

8. The book as described in claim 1, wherein the bound-in removable interactive element can be removed and re-inserted into its outline within the supporting material of the covers or pages of the book

9. The book as described in claim 3 wherein the material comprises a laminate.

10. The book as describe in claim 1 further comprising words, pictures, drawings and combinations thereof.

11. The book as described in claim 1 wherein the front and back surfaces of the removable interactive element are substantially level with the surfaces of the covers and pages of the book.

12. The book as described in claim 1 wherein the shape of the bound-in removable interactive element is indistinguishable within the surface of the covers and/or pages of the book.

13. The book as described in claim 1 wherein the removable interactive element is provided with a magnetized surface, light source, sound capabilities, stickers, or combinations thereof.

14. The book as described in claim 1 wherein the binding means is the same material as the removable interactive element, front cover, back cover and pages of the book.

15. The book as described in claim 1 wherein the binding means is not the same material as the removable interactive element, front cover, back cover and pages of the book.

16. The book as described in claim 1 wherein the thickness of the removable interactive element differs from the thickness of the front cover, back cover and pages of the book.

17. The book as described in claim 1 wherein the surfaces of the page or cover of the book which comprise at least one bound-in removable interactive element appears as a single component having a substantially smooth and continuous surfaces.

18. The book as described in claim 1 wherein a graphic is printed onto a surface of a page or cover and the outline of the removable interactive element corresponds to the outline of the graphic.

19. The book as described in claim 1 wherein the binding means comprises an adhesive, ring binding, male/female mating-type bindings, spiral bindings, stitching, slide-on type clip bindings, and combinations thereof.

20. A method for making a book comprising at least one bound-in removable interactive element, said method comprising:
i) fabricating a front cover, a back cover, at least one page between the front and back covers from a material that can be die-cut;
ii) binding said front cover, back cover, and at least one page with a binding means; and,
iii) die-cutting into at least one of said front cover, back cover and at least one page at least one said removable interactive element having a front and back side, wherein the front and back sides of the removable interactive element are integral with front and back sides of the front cover, back cover, or page of said book and the removable interactive element is removable and insertable from either the front or back side of the front cover, back cover and pages of the book.
